(19) United States
(12) Patent Application Publication
(10) Pub. No.: US 2026/0300246 A1
(43) Pub. Date: Oct. 1, 2026

(54) Hybrid Graph Indexing for Billion-Scale Approximate Nearest Neighbor Search

(71) Applicant: Couchbase, Inc., San Jose, CA (US)

(72) Inventors: John Sae Liang, Palo Alto, CA (US); Saptarshi Sen, San Jose, CA (US)

(21) Appl. No.: 19/389,647

(22) Filed: Nov. 14, 2025

Related U.S. Application Data
(60) Provisional application No. 63/777,593, filed on Mar. 25, 2025.

(51) Int. Cl. G06F 16/22; G06F 16/2455; G06F 16/248; G06F 16/28

(52) U.S. Cl. CPC G06F 16/2237; G06F 16/2455; G06F 16/248; G06F 16/285

(57) ABSTRACT

A system for approximate nearest neighbor search on a vector dataset clusters a plurality of vectors into multiple cells, each cell associated with a centroid. For each cell, the system generates a graph linking vectors that are sufficiently close to one another, associating each graph with a snapshot identifier indicating a version of cell data and a sequence number indicating a number of vectors added to the cell. Upon receiving a query for nearest neighbors of a target vector, the system traverses centroids to identify one or more centroids closest to the target, the centroids corresponding to one or more cells. For each such cell, the system performs a graph‑based search to identify candidate neighbors, determines a distance between the target vector and each candidate, and selects one or more nodes based on these distances. The system outputs the selected nodes as query results.

### CROSS-REFERENCE TO RELATED APPLICATION

This application claims priority to U.S. Provisional Patent Application No. 63/777,593, filed on Mar. 25, 2025, the entire contents of which are hereby incorporated by reference.

### TECHNICAL FIELD

The present disclosure relates generally to database management, and more specifically to approximate nearest neighbor (ANN) search on large-scale vector databases.

### BACKGROUND

Existing approximate nearest neighbor (ANN) search systems operating on large‑scale vector datasets—such as those containing billions of vectors—suffer from a range of performance and scalability limitations. Common challenges include excessive memory consumption, lengthy index build times, high computational workload during query execution, and inadequate mechanisms for efficiently processing real‑time updates to the dataset.

Some existing ANN solutions rely on in‑memory data structures that must store all vectors and their connectivity information for searching. While such approaches can achieve high search accuracy and low query latency at smaller scales, the requirement to keep the entire index in memory leads to impractical or cost‑prohibitive resource demands as dataset size grows into the billions.

Other approaches attempt to reduce memory usage by storing portions of the index on secondary storage. Although this can lower the in‑memory footprint, it often results in significant preprocessing overhead, with index construction for very large datasets taking many hours or even days. This high build cost makes such systems ill‑suited for workloads involving dynamic or frequently updated data, where index structures must be rebuilt or updated rapidly and incrementally.

Techniques that partition the dataset into clusters or regions can improve memory efficiency and limit the scope of searches. However, these methods frequently require exhaustive comparisons within each selected region, leading to high processor utilization and slower queries—particularly when regions contain large numbers of vectors. In addition, many existing clustering‑based systems lack efficient update processes, so insertions, deletions, or modifications can degrade search quality unless the index is reconstructed from scratch.

### SUMMARY

The present disclosure addresses the above-described problem by performing approximate nearest neighbor (ANN) search on large‑scale vector datasets using a hybrid clustering and graph‑based approach. In some embodiments, a plurality of vectors is clustered into a plurality of cells, each cell associated with a centroid. For each cell, a graph is generated linking vectors that are sufficiently close to one another according to a similarity metric. Each such graph is associated with a snapshot identifier, representing a version of data in the cell at a given time, and a sequence number, representing a total number of vectors inserted into the cell as of the graph’s creation. In some embodiments, graphs associated with centroids determined to be frequently accessed in query processing are cached in memory, while graphs for less frequently accessed centroids are stored on disk. This selective caching enables the system to operate at billion‑scale datasets with reduced total memory usage while maintaining low query latency for frequently accessed graphs.

During query processing, one or more centroids closest to a target query vector are identified by traversing a plurality of centroids, which may be arranged in a routing layer graph. The identified centroids correspond to one or more cells. For each such cell, a graph‑based search is performed to locate one or more candidate nearest neighbors of the query vector. Distances between the query vector and each candidate nearest neighbor are determined, and the nearest neighbors are selected based on these distances and output as query results.

In some embodiments, the system supports incremental updates by receiving mutations in a new snapshot interval. The mutations can include insertions of new vectors, deletions of existing vectors, or modifications of vectors. A rebuild condition is evaluated for the corresponding graph, and, in response to the rebuild condition being met, a new sequence number is determined based on the mutations. The graph is updated to include the mutated vectors and is associated with the new sequence number. The rebuild condition may be defined as a number of mutations exceeding a threshold or a percentage increase in node count relative to the last graph build. Each new vector may be assigned a monotonically increasing sequence number upon insertion, and the graph’s new sequence number may correspond to the highest sequence number of vectors included in the updated graph.

When updating the graph in response to deletions, the system can identify a nearest neighbor of the deleted node and replace edges to the deleted node with edges to the nearest neighbor. Such replacement can be subject to duplicate‑connection checks, whereby an edge is only added if it does not already exist, and similarity‑distance tolerance checks, whereby an edge is only added if its similarity distance is within a pre‑defined threshold.

In some embodiments, edges of each graph are stored in a memory‑efficient encoded format. A first vector position corresponding to a first node can be stored in a first data structure with a first bit length. For each subsequent node, a delta value between the node's position and the previous node's position is determined and stored using a second bit length selected according to the magnitude of the delta. The second bit length may be further determined based on whether the number of nodes in the graph exceeds a first threshold and whether the delta exceeds a second threshold. This encoding reduces memory usage compared to fixed‑width edge storage while preserving traversal performance.

By combining centroid‑based clustering, per‑cell graph indexing with snapshot identifiers and sequence numbers, incremental update logic with rebuild conditions, duplicate‑ and distance‑based edge replacement rules, memory‑efficient edge encoding, and routing layer traversal for centroid selection, the disclosed technique achieves high‑accuracy ANN search with reduced memory consumption, efficient handling of dynamic workloads, and improved search and update performance for large‑scale vector datasets.

### BRIEF DESCRIPTION OF THE DRAWINGS

FIG. 1 is an example system environment in which a distributed database system may be implemented, in accordance with one or more embodiments.

FIG. 2 illustrates an example index server configured to perform hybrid IVF-graph indexing and search operations, in accordance with one or more embodiments.

FIG. 3 illustrates an example process for inserting vector into an index, in accordance with one or more embodiments.

FIG. 4 depicts an exemplary process for building a nearest-neighbor graph for a cell, in accordance with one or more embodiments.

FIG. 5 illustrates an exemplary process for executing a hybrid approximate nearest neighbor (ANN) search, in accordance with one or more embodiments.

FIG. 6 illustrates an example of a multi-layer nearest-neighbor graph structure, such as a hierarchical navigable small world (HNSW) graph, with numbered elements representing specific nodes and layers, in accordance with one or more embodiments.

FIG. 7 illustrates a flowchart of an example method for snapshot-based hybrid ANN search, in accordance with one or more embodiments.

FIG. 8 is a high-level block diagram illustrating a functional view of a typical computer system for use as one of the entities illustrated in the system environment of FIG. 1 according to an embodiment.

The figures depict embodiments of the present disclosure for purposes of illustration only. One skilled in the art will readily recognize from the following description that alternative embodiments of the structures and methods illustrated herein may be employed without departing from the principles, or benefits disclosed, of the disclosure described herein.

### DETAILED DESCRIPTION

Existing approximate nearest neighbor (ANN) search on large-scale vector datasets – e.g., at the billion-vector scale – fall short in one or more of the following areas: memory inefficiency, slow index build time, high CPU load during queries, and limited support for real-time updates.

Graph-based ANN methods, such as the hierarchical navigable small world (HNSW) graph algorithm, are known for delivering high recall and fast search times in moderate-sized datasets. These methods construct a multi-layer graph where each node represents a vector, and edges connect neighboring nodes based on a similarity metric. While effective at smaller scales, such methods require storing the entire graph structure—including all vectors and neighbor links—in memory. At billion-vector scale, this results in extreme memory requirements that are often impractical or cost-prohibitive for many real-world systems.

Other large-scale ANN solutions, such as DiskANN, are designed to operate with a reduced memory footprint by offloading parts of the index to disk. However, these solutions often incur significant preprocessing costs: for example, building an index for a billion vectors may take over 60 hours of computation on high-performance, multi-core hardware. This makes them unsuitable for dynamic or frequently updated datasets, where reindexing must occur rapidly and incrementally.

Inverted file index (IVF)-based approaches offer better memory efficiency by clustering vectors around centroids and limiting searches to nearby clusters. However, these methods typically perform brute-force comparisons within selected clusters, which results in high CPU usage and slower query times, especially when large clusters must be scanned. Additionally, IVF methods often lack robust mechanisms for handling real-time data mutations—such as insertions, deletions, and modifications—without degrading index quality or requiring complete rebuilds.

Accordingly, there remains a need for an improved ANN search framework that combines the accuracy and performance benefits of graph-based techniques with the scalability, memory efficiency, and updatability required for billion-scale datasets. The present disclosure relates to systems and methods for performing memory-efficient, scalable, and consistent approximate nearest neighbor (ANN) search on large-scale vector datasets. As the volume of high-dimensional vector data continues to grow, traditional approaches to ANN search face significant challenges in terms of memory consumption, index update latency, and search accuracy. The techniques described herein address these challenges through a novel combination of clustering, graph-based search, snapshot-based versioning, and compact graph encoding.

In some embodiments, the system employs a hybrid ANN search method. A set of vectors is clustered into cells based on proximity to centroids, and a local graph is generated within each cell linking vectors that are sufficiently close to one another. At query time, the system identifies centroids closest to the query vector and performs a graph-based search within the corresponding cells. Candidate neighbors from each cell are evaluated based on a distance metric to return high-quality approximate nearest neighbors. This approach achieves both high search accuracy and scalability at billion-vector scale by limiting expensive computations to relevant subgraphs.

In some embodiments, the system applies a snapshot-driven mechanism for maintaining ANN indexes over time. Each new vector inserted into the system is associated with a snapshot identifier and a monotonically increasing sequence number. Graphs are periodically generated or rebuilt for each cell based on vectors inserted during defined snapshot intervals. When a query is received, it is evaluated against the graph corresponding to a specified snapshot identifier. The nearest neighbors are identified from the graph corresponding to the specified snapshot identifier.

In some embodiments, the system implements a memory-efficient encoding scheme for storing neighbor relationships in graphs. Each node in the graph is assigned an integer position, and its neighbors are sorted in ascending order by position. The first neighbor is encoded with a fixed number of bytes, while subsequent neighbors are encoded using delta values—representing the positional difference from the previous neighbor. The method adaptively selects a bit-length encoding scheme for each delta based on the number of nodes in the graph and the magnitude of the delta, enabling compact representation of neighbor lists without compromising graph traversal performance. In some embodiments, the system is also able to store less frequently used data on disk, while caching active components for performance.

The disclosed system delivers significant performance and resource‑use improvements over existing billion‑scale ANN methods. Compared to conventional IVF approaches, the hybrid IVF‑graph search reduces the number of distance comparisons and the volume of vectors scanned per query, producing up to 2.5×–7.6× faster query execution for equivalent recall. Memory usage is reduced to approximately 41 GB for edge storage versus about 120 GB for fixed‑width monolithic graphs. Index build time is shortened substantially, with one billion vectors indexed in around 16 hours versus 60 hours or more for DiskANN on similar hardware. Mutation processing is more CPU‑efficient than segment merge or DiskANN, because updates are applied locally within the affected cell graph rather than requiring rebuilds of large monolithic graphs. These improvements are achieved through clustering, per‑cell graph indexing, snapshot‑driven updates, compact edge encoding, and optimized traversal strategies incorporating long‑range edges where beneficial.

### System Environments

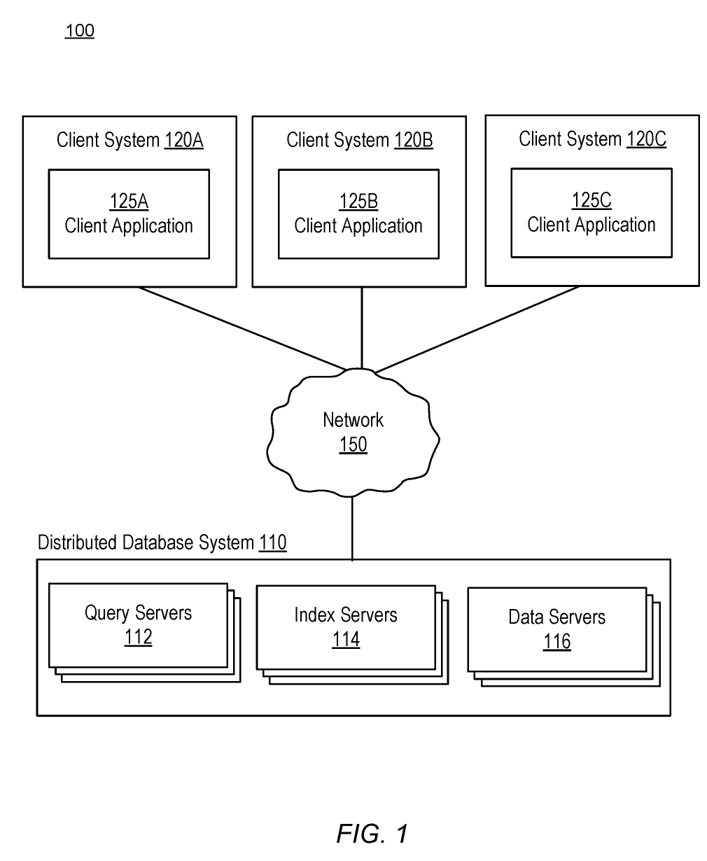

FIG. 1 is an embodiment of a block diagram of system environment 100 in which a distributed database system may be implemented. In the embodiment shown, the system environment 100 includes a distributed database system 110, client systems 120, and a network 150. Other embodiments may use more, fewer, or different systems than those illustrated in FIG. 1. Functions of various modules and systems described herein can further be implemented by other modules or systems than those described herein.

The distributed database system 110 manages a distributed database. The distributed database system 110 includes a set of distributed database nodes including distributed query servers 112, distributed index servers 114, and distributed data servers 116. The distributed database nodes may be individual servers or server clusters, virtual database nodes distributed to one or more physical servers, or some combination thereof.

The client systems 120 (e.g., the client systems 120A, 120B, or 120C) are client computing systems that communicate with the distributed database system 110 to execute transactions. The client system 120 may include one or more computing devices, such as personal computers (PCs), mobile phones, server computers, laptops, or workstations.

The client systems 120 each include a client application 125 (e.g., the client applications 125A, 125B, and 125C) that communicates with the distributed database system 110 via one or more interfaces, which may include application programming interfaces (APIs) and command‑line tools such as kubectl or Helm. For instance, the distributed database system 110 might provide a Representational State Transfer (REST) API to facilitate communication with the client systems 120. In an exemplary embodiment, the client systems 120 may: communicate directly with the data servers 116 using the client applications 125 to execute transactions on data stored in the data servers 116.

In embodiments, the client systems 120 communicate with the distributed database system 110 to execute transactions in the distributed database. The transactions may be generated by the client systems 120 via the client applications 125 or other processes executing on the client system 120. Furthermore, the client systems 120 can receive data from the distributed database system 110, such as data requested in a transaction. In an exemplary embodiment, the client systems 120 execute transactions by communicating directly with one or more of the data servers 116. In the same or different embodiments, the client systems 120 communicate with other components of the distributed database system 110 to execute transactions, such as the query servers 112 or the index servers 114. As an exemplary case, transactions executed by the client systems 120 may make modifications to existing records stored by the data servers 116 (i.e., mutations), may add new records for storage in the data servers 116 (i.e., insertions), or may remove records from storage in the data servers 116 (i.e., deletions). Furthermore, although techniques for executing transactions are described herein primarily in relation to mutations and insertions, one skilled in the art will appreciate that other database operations are possible using the same or similar techniques, such as deletions

In some embodiments, the client application 125 of a client system 120 communicates with the distributed database system 110 via software integrated with a software development kit (SDK) on the client system 120. For instance, the SDK may be an SDK configured for executing transactions at the distributed database system 110. In this case, the client application 125 may execute transactions at the distributed database system 110 using software tools provided by the SDK, such as transaction execution functions, user defined functions, or eventing functions (e.g., Eventing Functions). The SDK may be implemented using any suitable programming language (e.g., Java, C++, Python, etc.). The SDK may provide an application programming interface (API) to the client application 125 for executing transactions or otherwise performing operations at the distributed database system 110. Alternatively, or additionally, the client applications 125 may communicate directly with the distributed database system 110 via the same or different API.

The interactions between the client systems 120 and the distributed database system 110 are typically performed via a network 150, for example, via the Internet or via a private network. In one embodiment, the network uses standard communications technologies or protocols. Example networking protocol include the transmission control protocol/Internet protocol (TCP/IP), the user datagram protocol (UDP), internet control message protocol (ICMP), etc. The data exchanged over the network can be represented using technologies and/or formats including JSON, the hypertext markup language (HTML), the extensible markup language (XML), etc. In another embodiment, the entities can use custom or dedicated data communications technologies instead of, or in addition to, the ones described above. The techniques disclosed herein can be used with any type of communication technology, so long as the communication technology supports receiving a web request by the distributed database system 110 from a sender, for example, a client system 120 and transmitting of results obtained by processing the web request to the sender.

The distributed database system 110 enables the client systems 120 to execute transactions on data stored in the data servers 116 via communication with one or more components of the distributed database system 110. In an exemplary embodiment, the client systems 120 execute transactions by communicating directly with the data servers 116. Although FIG. 1 shows a single element, the distributed database system 110 broadly represents a distributed database including the distributed query servers 112, the index servers 114, and the data servers 116 which may be located in one or more physical locations. The individual elements of the distributed database system 110 may be any computing device, including but not limited to: servers, racks, workstations, personal computers, general purpose computers, laptops, Internet appliances, wireless devices, wired devices, multi‑processor systems, mini‑computers, cloud computing systems, and the like. Furthermore, the elements of the distributed database system 110 depicted in FIG. 1 may also represent one or more virtual computing instances (e.g., virtual database nodes), which may execute using one or more computers in a datacenter such as a virtual server farm. As such, the query servers 112, index servers 114, and data servers 116 may each represent one or more database nodes, such as one or more virtual database nodes, executed on one or more computing devices.

The query servers 112 facilitate queries on the distributed database. In particular, the query servers 112 may process query statements received from the client systems 120 represented using one or more query languages (e.g., structured query language (SQL), GraphQL, non-first normal form query language (N1QL), etc.). The query servers 112 may generate query execution plans (QEPs) using received query statements. QEPs may be generated using various techniques, such as those described in U.S. Patent Application No. 16/785,499, filed February 7th, 2020, issued as U.S. Patent No. 11,200,230, which is incorporated herein by reference in its entirety. In some embodiments, the query servers 112 facilitate execution of transactions including one or more statements represented using a declarative query language, such as by using any of the methods described in U.S. Patent Application No. 17/007,561, filed August 31st, 2020, issued as U.S. Patent No. 11,681,687, which is incorporated herein by reference in its entirety.

The index servers 114 manage indexes for data stored in the distributed database system 110. In various embodiments, the index servers 114 can receive requests for indexes (e.g., during execution of a transaction) from the query servers 112, directly from the client systems 120, or another element of the system environment 100. In addition to managing conventional index types such as B‑tree indexes, inverted indexes, hash indexes, R‑tree indexes, GIST indexes, or other suitable database indexes, the index servers 114 can also generate and maintain approximate nearest neighbor (ANN) vector indexes for high‑dimensional vector datasets stored by the data servers 116.

In some embodiments, the ANN vector index is implemented as a hybrid IVF‑graph index in which vectors are clustered into cells associated with centroids, and a nearest‑neighbor graph is constructed for the vectors in each cell. Each graph is associated with a snapshot identifier and a sequence number to support versioned query processing and incremental updates. The index servers 114 may automatically build initial hybrid IVF‑graph structures, update per‑cell graphs based on mutation thresholds, apply memory‑efficient neighbor encoding, and perform query‑time merging of graph search results with new mutations.

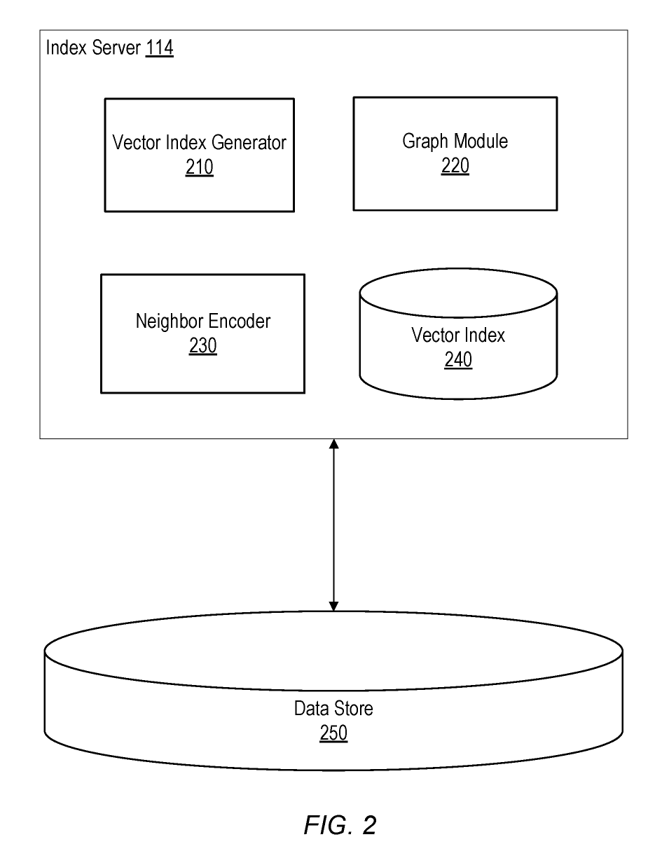

Index build and update operations may be initiated automatically based on transactions performed in the distributed database system 110 or in response to explicit instructions from another component such as a query server 112. In some embodiments, a given index server 114 manages vector and non‑vector indexes stored on a corresponding index storage server or server cluster; in other embodiments, it manages indexes stored locally on a data server 116. As described above with reference to the distributed database system 110, an index server 114 may be implemented as one or more virtual database nodes executed on one or more computing devices (e.g., server computers or clusters), where each computing device can host one or more virtual database nodes. Additional details about the index server 114 are further described below with respect to FIG. 2.

The data servers 116 manage data organized into records in a distributed database of the distributed database system 110. In various embodiments, the data servers 116 can provide requested data to other elements of the system environment 100 (e.g., the query servers 112) and store new or modified data in the distributed database. In particular, the data servers 116 can commit new or modified data to the distributed database in response to receiving instructions to execute corresponding transactions directly from the client systems 120. In processing instructions to execute transactions, the data servers 116 maintain the ACID properties of transactions (atomicity, consistency, isolation, and durability).

The distributed database may be one of various types of distributed databases, such as a document‑oriented database, a key‑value store, a graph database, a relational database, a wide‑column database, or a search index. In embodiments in which the distributed database includes a vector index, records storing data may include high‑dimensional vector embeddings associated with unique identifiers that map to application‑level objects. These vector records may be indexed using the hybrid IVF‑graph ANN search techniques described herein, in which each cell in an inverted file index is associated with a nearest‑neighbor graph stamped with a snapshot identifier and sequence number to support efficient and consistent search operations.

Similarly, records may be represented using various formats or schemas based on the type of database used, such as relational tables, JSON documents, XML documents, or binary formats for vector data. In some embodiments, a given data server of the data servers 116 manages data stored on a corresponding data storage server or server cluster. In some embodiments, a given data server of the data servers 116 manages data stored locally on the given data server. As described above with reference to the distributed database system 110, a data server 116 may be a virtual database node executed on one or more computing devices (e.g., a server computer or server cluster), where each of the one or more computing devices can include one or more virtual database nodes.

FIG. 2 illustrates an embodiment of an index server configured to perform hybrid IVF‑graph indexing and search operations in accordance with aspects of the present disclosure. In the depicted embodiment, index server 114 includes a vector index generator 210, a graph module 220, a neighbor encoder 230, and a vector index 240. These components cooperate to build, maintain, and query a hybrid inverted file (IVF) index in which each centroid is associated with a nearest‑neighbor graph. The index server 114 is communicatively coupled to a data store 250 that persists vector data and associated index structures.

The vector index generator 210 receives vectors for insertion and assigns each vector to a cell corresponding to the closest centroid. It organizes vectors into memory‑resident and disk‑resident queues, assigns unique identifiers and snapshot values, and updates cell sequence data.

For example, when a new vector V101 is received, the vector index generator 210 calculates its similarity to each existing centroid in the inverted file structure. Suppose the highest similarity score corresponds to Centroid_7. The vector index generator 210 then assigns V101 to the cell associated with Centroid_7. The system’s current snapshot identifier is SN:20, so V101 is tagged with snapshot number 20. The generator assigns a unique vector identifier, such as ID_0000101, which is monotonically increasing across insertions. Because the cell’s memory‑resident queue has not yet reached its flush threshold, V101 is placed in memory rather than on disk. At the same time, the cell’s sequence counter (seqno) is incremented from 100 to 101 to reflect the total number of vectors seen by this cell. In later operations, when the flush threshold is reached or the system initiates a snapshot flush, vectors from the memory‑resident queue, including V101, will be persisted to the disk‑resident queue to free memory for new insertions.

The graph module 220 constructs nearest‑neighbor graphs for each cell using vectors up to a designated snapshot, stamps each graph with its associated snapshot and sequence identifiers, and performs incremental updates when mutation thresholds are met. The graph module 220 may also traverse graphs during query execution to identify candidate neighbors.

In some embodiments, the graph module 220 manages the lifecycle of nearest‑neighbor graphs for each cell. Each graph created by the graph module 220 is immutable once built. Rather than modifying an existing graph in place, the graph module 220 generates a new version when the number of mutations since the last build exceeds a pre‑defined threshold. This embodiment maintains graph consistency and prevents degradation of recall accuracy that can result from incremental edge modifications.

When processing an insertion, the graph module 220 identifies the nearest neighbors of the newly inserted vector within the existing graph for the corresponding cell. The module then connects the new vector to its nearest neighbors by adding bidirectional edges. This allows the updated graph structure to support traversal including the new node without requiring a complete rebuild for each insertion event.

When processing a deletion, the graph module 220 locates the nearest neighbor of the vector slated for removal from the cell graph. All edges in the graph pointing to the deleted node are replaced with edges to its nearest neighbor. Before adding a replacement edge, the graph module 220 checks for duplicate connections to prevent redundant storage. It also applies a similarity tolerance threshold; if an edge would connect two nodes whose similarity distance exceeds the threshold, the edge is not added.

For cells with frequent updates, the graph module 220 may evaluate whether the rebuild threshold has been reached. The threshold may be based on the absolute number of mutations or on a percentage increase in node count relative to the last snapshot. If the threshold is met, the graph module 220 constructs a new graph version using all vectors in the cell up to the current snapshot and associated sequence number. The new graph is stamped with this snapshot identifier and sequence number, enabling query operations to use the most recent graph version and merge in any remaining mutations as needed.

In some embodiments, the graph module 220 implements additional optimization measures when handling mutations to limit rebuild cost and preserve traversal performance. Mutations may be accumulated in memory and processed as batches before triggering a graph rebuild, thereby reducing the frequency of graph reconstruction operations. When replacing edges during deletion processing, the module applies duplicate and similarity‑tolerance checks to avoid connecting nodes with redundant links or with distances exceeding the configured threshold, preventing graph bloat, and preserving edge quality.

The graph module 220 may also selectively retain certain long‑range edges in the cell graph. These edges link nodes that are far apart in the similarity space but act as shortcuts during traversal, reducing the number of hops needed to reach distant regions of the graph. Retaining high‑value long‑range edges helps maintain fast query response times even as the dataset grows or mutates, and can offset the impact of fewer short‑range edges caused by pruning during maintenance operations.

In some embodiments, the graph module 220 determines whether two nodes should be linked by evaluating similarity distance between their corresponding vectors and applying heuristics and thresholds. The graph module 220 receives vectors to be added to a cell’s nearest‑neighbor graph. For each new vector or during graph construction, the graph module 220 computes the similarity distance between the candidate node and other nodes in the same cell using a chosen metric such as Euclidean distance or cosine similarity. It then selects the closest nodes up to a fixed neighbor limit for that graph, for example thirty‑two neighbors per node in most cells, and may include long‑range edges to improve graph traversal efficiency.

In some embodiments, before establishing a link between two nodes, the graph module 220 applies conditions to ensure link quality and efficiency. The similarity distance between the two vectors is less than or equal to a pre‑defined threshold so that only sufficiently close nodes are connected. The graph module 220 may also check whether a connection between the two nodes already exists, either directly or through recently updated edges, to avoid redundant links. If an existing neighbor has been deleted, the edge may be replaced with a link to the deleted node’s nearest neighbor, subject to the same distance threshold.

These evaluations are performed whether the link creation occurs during the initial graph build, incremental insertion, or mutation processing. If the similarity threshold is satisfied and duplication is avoided, the graph module 220 records a bidirectional edge between the two nodes in the graph structure.

The neighbor encoder 230 applies a memory‑efficient encoding scheme to store graph edges, assigning integer positions to nodes, sorting neighbor lists, and encoding connections using delta values or absolute positions depending on graph size and delta magnitude. This compact representation reduces memory usage compared to fixed‑width edge storage.

For example, in a graph with 10,000 nodes, the neighbor encoder 230 may assign node A the integer position 150 and sort its neighbors in ascending order by position, resulting in a sorted list such as: position 200, position 208, and position 350. The first neighbor’s position (200) is stored using four bytes. For the second neighbor, the encoder calculates the delta between positions 208 and 200, yielding a delta of 8. Because the graph has fewer than 65,535 nodes and the delta is less than or equal to 127, the delta is stored in a single byte with its most significant bit set to “1” to indicate a delta value rather than an absolute position. For the third neighbor, the delta between 350 and 208 is 142. As this exceeds 127, the encoder stores the absolute position of 350 using two bytes. This approach avoids using four bytes for every neighbor, thereby reducing per‑edge storage, and improving overall index memory efficiency.

In another example, the neighbor encoder 230 operates on a graph containing 100,000 nodes, which exceeds the 65,535‑node threshold. Suppose node B is assigned the integer position 50,000, and its sorted neighbor list in ascending position order is: position 60,000, position 60,500, and position 65,000. The first neighbor’s position (60,000) is stored using four bytes.

For the second neighbor, the encoder calculates the delta between positions 60,500 and 60,000, yielding a delta of 500. In the branch for graphs with more than 65,535 nodes, the rule is: If delta ≤ 32,767, store the delta in two bytes with the most significant bit (MSB) set to “1” to indicate a delta value. If delta > 32,767, store the absolute position in four bytes. Here, delta 500 ≤ 32,767, so the encoder stores this delta in two bytes with its MSB set to “1.”

For the third neighbor, the delta between 65,000 and 60,500 is 4,500, which is also ≤ 32,767, so it is stored in two bytes with the MSB set to “1.” If, in a different scenario, a neighbor had a delta of, for example, 40,000 from the previous neighbor, this would exceed 32,767. In that case, the encoder would store the neighbor’s absolute position using four bytes rather than storing a delta.

By applying this branch of the encoding logic, the neighbor encoder 230 ensures that even in very large graphs, each edge is stored in as few bytes as possible while accommodating large deltas when needed.

The vector index 240 maintains the hybrid IVF‑graph structure, including centroids, associated vectors, and the encoded neighbor graphs. The data store 250 holds the persisted vector data, index structures, and historical snapshot information to support queries merging graph data with recent mutations.

This configuration enables the index server 114 to execute all aspects of the hybrid IVF‑graph ANN method, including vector insertion, index building, neighbor encoding, and query processing using both stored graphs and new mutations.

Performance evaluations demonstrate the advantages of the hybrid IVF‑graph approach. For a given recall target, the hybrid method reduces total distance comparisons compared to IVF and lowers IOPS by scanning fewer candidate vectors. In one evaluation, at high recall the system performed query scans with approximately 36,000 distance comparisons versus over 90,000 for IVF. Memory consumption for graph edge storage was measured at roughly 41 GB using the compact neighbor encoding scheme described herein, in contrast to approximately 120 GB for fixed‑width in‑memory monolithic graphs. Index construction for one billion vectors completed in about 16 hours on multi‑core hardware, compared to 60 hours or more for a DiskANN build on comparable resources. Mutation handling required fewer CPU cores than DiskANN for equivalent update rates because of localized per‑cell graph updates.

In some embodiments, the hybrid IVF‑graph ANN system employs a flexible disk and memory storage strategy to balance performance and resource consumption. Components of the graph and associated vector data managed by index server 114 can be selectively stored in memory or persisted to data store 250 based on usage patterns, available storage capacity, and desired query latency. In some embodiments, each centroid has an associated graph, and graphs for centroids determined to be frequently accessed are cached in memory as complete units.Graphs for less frequently accessed centroids are stored on disk and can be loaded into memory when their access frequency increase.

The vector index 240 within the index server 114 maintains a cache of whole graphs for centroids with high query access counts, along with associated centroid data and vector data in memory. Caching whole graphs reduces input/output (IO) overhead during queries by allowing traversal to be performed without disk reads for those graphs. Less frequently accessed centroids’ graphs and associated vector data are persisted in the data store 250, enabling the system to scale to billion‑vector datasets without requiring all graphs to reside in memory.

In some embodiments, the graph module 220 supports disk‑resident graphs, wherein the complete graph for a centroid is stored in the data store 250 rather than held in memory. When traversing a disk‑resident graph during query execution, the graph module 220 retrieves the graph from disk as needed. To limit IO impact, the vector index 240 can load graphs into memory for centroids that become more frequently accessed and evict graphs for centroids whose access frequency decreases, maintaining a balance between available memory and query performance. When operating with high‑performance NVMe‑based storage in the data store 250, retrieval of disk‑resident graphs can achieve query latencies close to those of fully memory‑resident graphs while preserving the capability to store very large datasets.

In some embodiments, the performance of disk‑resident graphs in the data store 250 is determined in part by the input/output (IO) characteristics of the underlying storage device. High‑performance NVMe‑based storage can provide IO latencies low enough that traversal of disk‑resident graphs approaches the performance of fully memory‑resident graphs. In contrast, traditional SATA‑based solid‑state drives or hard disk drives present higher latencies for random reads, which may require adjustments such as increasing in‑memory caching or reducing the number of disk edge lookups during query traversal to maintain acceptable performance.

To reduce IO load, the index server 114 may prioritize caching entire graphs in the vector index 240 based on query access patterns. Each centroid has a corresponding graph, and graphs that are accessed frequently in queries can be retained in memory as single units to avoid repeated disk fetches. Less frequently accessed graphs may be evicted from memory and reloaded from disk on demand. The caching process can be adaptive, refreshing the set of retained graphs over time according to observed query workloads. By combining selective ‑graph caching with high‑performance storage, the system enables disk‑resident graphs to operate efficiently at billion‑scale datasets while conserving memory resources.

Write operations, including graph updates described herein, are processed by the graph module 220 and stored temporarily in memory within the vector index 240 before being flushed to the data store 250 in batch operations. This batching minimizes random IO and improves throughput for mutation processing. By dynamically controlling which portions of the vector index 240 are memory‑resident and which are persisted to the data store 250, the index server 114 optimizes for both search performance and cost‑effective scaling.

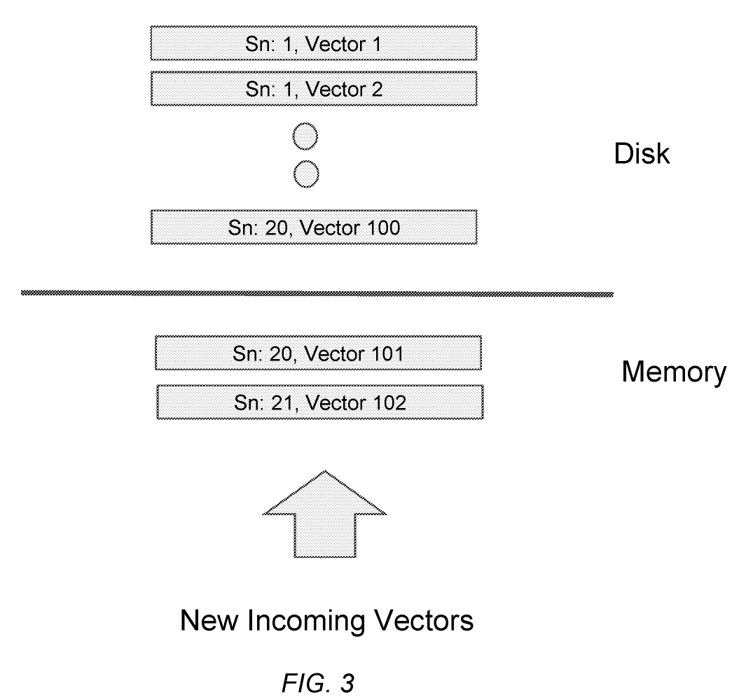

FIG. 3 illustrates an example process for inserting vector into an index in accordance with one or more embodiments. During insertion, each incoming vector is assigned to a cell corresponding to the closest centroid, where the centroid is determined using a similarity metric. The centroid represents a cluster in an inverted file (IVF) index structure.

In some embodiments, the system, through the vector index generator, uses a clustering algorithm such as mini‑batch k‑means to divide the vector space into cells, each characterized by a centroid. Before clustering begins, the system calculates the target number of centroids based on the total number of vectors in the dataset and a configured cell size threshold representing the maximum number of vectors permitted in a cell. For example, if the dataset contains one million vectors and the size threshold is set to 1,000, the system targets creation of approximately 1,000 cells, each averaging 1,000 vectors.

The clustering process may proceed in multiple iterations. In larger datasets, initial clustering produces a smaller number of coarse cells, each of which may then be recursively subdivided by applying the clustering algorithm again until all resulting cells meet the size threshold. In some embodiments, the system imposes a maximum limit on the number of centroids—for instance, 10,000—to control resource usage during index build, file management, and graph creation. If the computed number of cells exceeds this limit, the system caps the number of centroids accordingly. After clustering, the number of cells in the final index is therefore determined by this combination of total dataset size, the cell size threshold, the maximum centroid limit, and any recursive subdivision applied to oversized cells. The same logic applies when splitting cells during incremental updates; if a cell’s vector count grows beyond twice the configured size threshold, the system splits the cell into smaller cells until the threshold is met. In some embodiments, the cells are not split.

In some embodiments, the system employs a routing layer to identify the centroids closest to a query vector more efficiently than exhaustive centroid comparison. The routing layer is implemented as a graph structure whose nodes represent the centroids created during clustering. Edges between centroid nodes reflect proximity relationships based on similarity distance between the corresponding centroid vectors. By storing only the centroid graph in memory, the routing layer greatly reduces the amount of data that must be searched to locate the region of interest for a given query.

When a query is received, the system traverses the routing layer graph instead of computing the similarity distance between the query vector and every centroid. Starting from an entry point node in the centroid graph, neighbor centroids are visited by following graph edges in order of increasing similarity distance to the query. The traversal continues until a list of candidate centroids of the desired length (nprobe value) is found or until all reachable centroids closer than a specified threshold have been examined. This process has logarithmic time complexity relative to the number of centroids and returns the centroids most likely to contain nearest neighbors for the query vector.

After the candidate centroids are identified by the routing layer, the system proceeds to the per‑cell graph search described herein, limiting expensive vector‑to‑vector comparisons to those vectors in the cells whose centroids were selected. The routing layer may be updated incrementally when centroids are added, removed, or shifted as a result of clustering operations, ensuring that centroid proximity relationships remain accurate over time.

Each cell maintains a logical queue of vectors arranged based on insertion order. When a vector is inserted, it is assigned: a unique numeric identifier (id) that monotonically increases for each new vector, and a snapshot number (sn) that identifies the snapshot active at the time of insertion.

Initially, vectors are placed in a memory-resident queue within the cell. This queue accumulates vectors until a flush operation is triggered, at which time all vectors in the memory queue are persisted to disk. The disk-resident portion of a cell thereby stores older vectors, while the memory-resident portion stores recently inserted vectors not yet flushed.

Each cell further maintains a counter (seqno) representing the number of vectors that have been inserted into the cell. A mapping between sn and seqno is preserved for each cell, enabling the system to determine the sequence position of vectors for a given snapshot.

The diagram of FIG. 3 shows vectors assigned to snapshots sn: 1 through sn: 21. Vectors with sn: 1 through sn: 20 have been flushed to disk, while vectors added under later snapshots (sn: 21, etc.) are stored only in memory pending flush. Incoming vectors are continually assigned to the appropriate cell and processed according to this queuing and snapshot assignment mechanism.

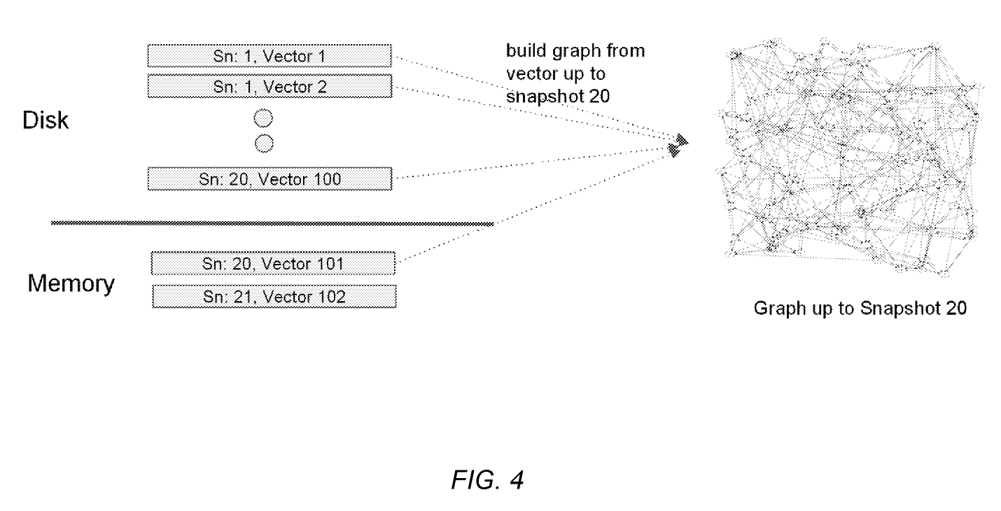

FIG. 4 depicts an exemplary process for building a nearest‑neighbor graph for a cell in accordance with one or more embodiments. Once an initial set of vectors has been inserted into a cell, the system constructs a nearest‑neighbor graph for that cell. The graph is configured to facilitate similarity search operations by connecting each vector node to a set of neighboring vector nodes determined according to a similarity metric.

Graph construction is performed using the set of vectors, including mutations, that have been inserted up to a specific snapshot. In the illustrated example, the graph is built up to snapshot 20, meaning that the graph will include only vectors having an sn value less than or equal to 20.

Vectors corresponding to the designated snapshot are retrieved from both the disk‑resident queue and the memory‑resident queue associated with the cell. The disk queue stores vectors that have been flushed from memory (e.g., sn: 1, Vector 1 through sn: 20, Vector 100), while the memory queue stores more recent, unflushed insertions (sn: 20, Vector 101; sn: 21, Vector 102). For graph building up to snapshot 20, only vectors with sn ≤ 20 are used.

When the graph has been constructed, it is stamped with: the snapshot number (sn) identifying the version of data from which the graph was built, and the sequence number (seqno) associated with that snapshot and cell.

The resulting graph structure, as shown on the right side of FIG. 4, represents connections among vectors inserted up to snapshot 20. This graph is stored for subsequent query operations, allowing traversal of vector neighborhoods to locate approximate nearest neighbors within the cell while excluding mutations occurring after the snapshot used for construction.

In some embodiments, the system utilizes a compact encoding scheme for storing edges in a nearest‑neighbor graph to improve memory utilization. Each node in the graph is assigned an integer position within the graph. Given a list of neighbors for a specific node, the neighbor list is sorted in ascending order according to each neighbor’s position value.

The position of the first neighbor in the sorted list is stored using a fixed 4‑byte field. For the remaining neighbors in the list, a delta encoding process is applied, wherein the position value of the current neighbor is subtracted from the position value of the previous neighbor. The resulting delta or an absolute position is then stored based on the size of the graph and the value of the delta.

When the graph contains more than 65,535 vectors, if the delta exceeds 32,767 the absolute position of the current neighbor is stored using 4 bytes. If the delta is less than or equal to 32,767, the leading bit of the delta is set to “1” and the delta is stored using 2 bytes. When the graph contains 65,535 or fewer vectors, if the delta exceeds 127 the absolute position of the current neighbor is stored using 2 bytes. If the delta is less than or equal to 127, the leading bit of the delta is set to “1” and the delta is stored using 1 byte.

This scheme allows the edge list for each node to use the smallest possible number of bytes for most neighbor connections, resorting to larger absolute position storage only when the delta value is too large to fit within the allocated smaller field. By combining position sorting with delta encoding, the graph’s edge storage is reduced from a conventional fixed‑width representation, such as 4 bytes per neighbor, to an average size of approximately 1.26 bytes per neighbor connection for typical cell sizes.

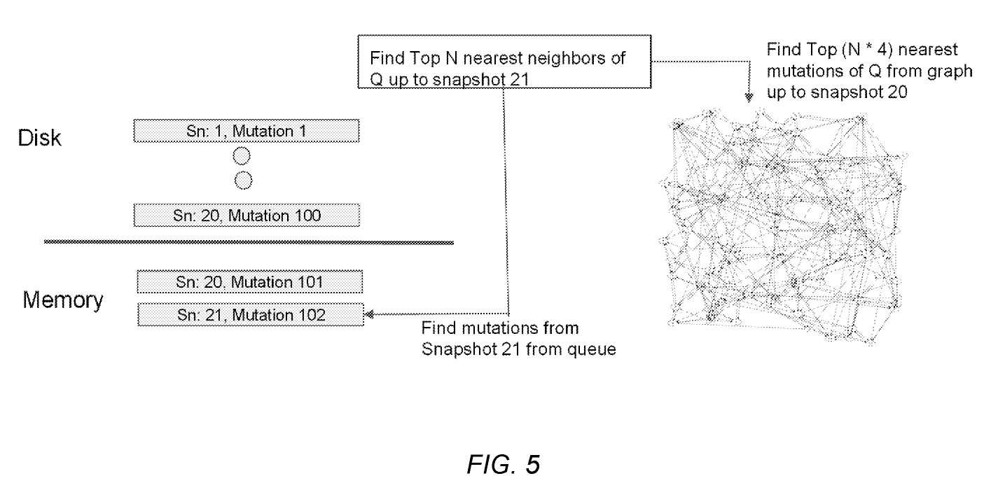

FIG. 5 illustrates an exemplary process for executing a hybrid approximate nearest neighbor (ANN) search in accordance with one or more embodiments. When a query vector is received, the system first determines the graph whose snapshot number (sn) is closest to the current snapshot number of the index. This graph represents the most recent stable version of neighborhood connections for vectors in the cell. Once identified, the graph is traversed to locate candidate nearest neighbors of the query vector. In the illustrated embodiment, the traversal returns the top (N × 4) nearest mutations of the query vector from vectors stored in the graph up to snapshot 20.

To ensure query results include recent updates not present in the graph used for traversal, the system reads new mutations from the cell’s queues if the cell’s current sequence number (seqno) is larger than the graph’s sequence number and the cell’s current sequence number is smaller than the current snapshot’s sequence number. Mutations meeting these criteria represent vectors inserted after the graph’s construction but before the current query snapshot.

As shown in FIG. 5, vectors with snapshot numbers up to 20 are stored on disk, with some vectors from snapshot 20 also present in memory. Vectors inserted under later snapshots, such as snapshot 21, reside only in memory until flushed. The system identifies mutations from snapshot 21 in the queue and evaluates them together with the candidates returned by graph traversal.

This hybrid approach merges candidates obtained from the prior graph build with newly inserted or updated vectors from recent snapshots, thereby producing the top N nearest neighbors of the query vector for the current snapshot while avoiding the computational cost of rebuilding the full graph for every mutation.

In some embodiments, the query server 112 determines whether additional mutations must be merged into query results by evaluating the relationship between snapshot numbers and sequence numbers recorded for the current cell and for the graph version selected for the query. When a query is received, the query server 112 first selects the graph whose snapshot identifier (sn_graph) is closest to, but not greater than, the current snapshot identifier (sn_current) at query time. This graph contains all vector and edge data up to its associated snapshot.

The query server 112 then compares the current cell’s sequence number (seqno_cell) with the graph’s recorded sequence number (seqno_graph). If seqno_cell is greater than seqno_graph, the query server 112 recognizes that additional vectors have been inserted into the cell after the graph was built. To ensure that these mutations are relevant to the query scope, the query server 112 also verifies that seqno_cell is less than or equal to the sequence number associated with sn_current. This two-step check ensures that only vectors inserted between the graph’s build snapshot and the current query snapshot are considered for merging.

If both conditions are met, the query server 112 issues requests to retrieve the relevant mutations from the memory-resident and disk-resident queues for the cell. These mutations are then evaluated alongside the candidate neighbors identified through graph traversal for the query vector. By performing this snapshot/sequence number evaluation, the query server 112 avoids unnecessary mutation merging in cases where no new vectors have been added since the graph build or where new vectors fall outside the query’s designated snapshot range.

This snapshot/seqno-based decision process enables the hybrid IVF‑graph ANN system to maintain high query throughput while ensuring that returned results reflect both the stable graph state and relevant recent mutations.

In some embodiments, the centroids generated during clustering are organized into a separate graph, which may be referred to as a routing layer. This routing layer contains nodes representing the centroids and edges representing proximity relationships among them. In some embodiments, the routing layer graph may itself be partitioned into a plurality of cells, each containing a centroid node. The centroids in this layer can also be organized into an additional, higher‑level graph, creating a hierarchical arrangement in which graphs at successive layers represent increasingly coarse relationships. Accordingly, the dataset may be structured as multiple layers of graphs, with the upper layers connecting centroids for broad navigation and the lower layers containing per‑cell graphs linking individual vectors.

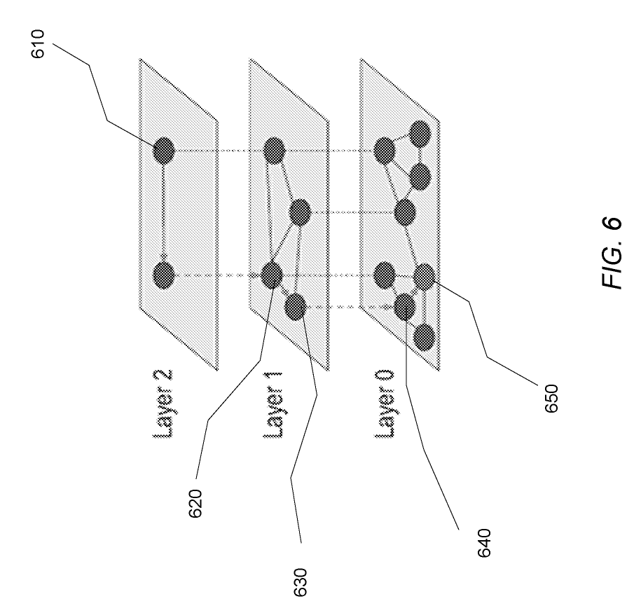

FIG. 6 illustrates an example of a multi‑layer nearest‑neighbor graph structure, such as a hierarchical navigable small world (HNSW) graph, with numbered elements representing specific nodes and layers. In the embodiment shown, node 610 in Layer 2 is a starting point for traversal. Layer 2 is the sparsest layer and contains long‑range links that allow movement between distant regions of the graph. Node 620 in Layer 2 is connected to node 610 and is approached along a dashed traversal path.

From node 620, the search descends to Layer 1, where node 630 is located. Layer 1 contains more nodes than Layer 2 and offers intermediate‑range links that enable navigation toward the target region in fewer steps than scanning all nodes at the base layer. Traversal continues downward along the dashed path to Layer 0.

In Layer 0, node 640 represents a position in the denser graph where most short‑range connections exist. The search then proceeds to node 650, which depicts the destination node or target region corresponding to the query vector. At Layer 0, traversal focuses on local neighborhoods, following short‑range edges to locate approximate nearest neighbors of the query vector.

This multi‑layer arrangement allows the system to begin in a sparse upper layer for coarse positioning and then move through progressively denser layers, reducing the number of distance computations compared to a flat graph traversal. In the context of the hybrid IVF‑graph design, FIG. 6 represents the routing layer centroid graph, where centroids are connected in a multi‑layer structure to enable efficient identification of the closest centroids before descending into their respective per‑cell graphs for fine‑grained vector search.

### Example Method

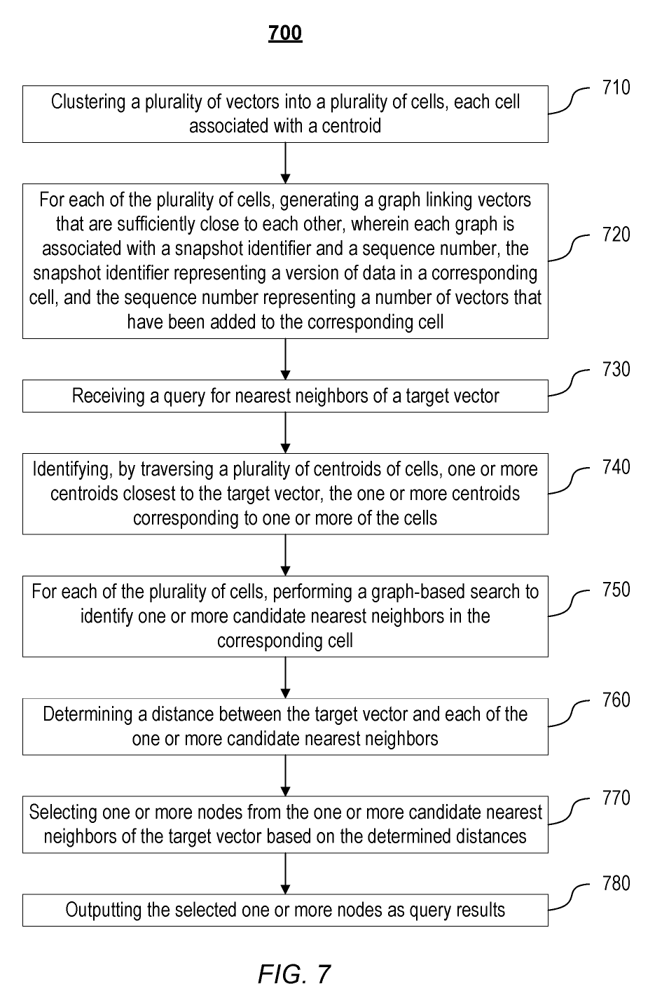

FIG. 7 illustrates a flowchart of an example method 700 for snapshot-based hybrid ANN search, in accordance with one or more embodiments. The steps in method 700 may be executed in an order different from that indicated herein. In various embodiments, the method 700 may include more or fewer steps as illustrated in FIG. 7. The steps may be performed by a system, for example, modules of the system 110 such as index server 114 and query module 220.

The system clusters 710 a plurality of vectors into a plurality of cells, each cell associated with a centroid. Clustering may be performed using a suitable algorithm, such as k‑means, mini‑batch k‑means, or other partitioning techniques, to group vectors that are close to one another according to a chosen similarity metric. The resulting centroids represent the central point or average position of vectors within each cell and serve as an indexable reference for identifying regions of the vector space during query processing. Each vector is assigned to the cell whose centroid is closest in similarity distance, thereby organizing the dataset into manageable and searchable segments.

For each of the plurality of cells, the system generates 720 a graph linking vectors that are sufficiently close to each other within that cell. The graph comprises nodes representing vectors and edges representing proximity relationships based on a similarity distance metric. In some embodiments, each graph is associated with a snapshot identifier and a sequence number. The snapshot identifier represents a version of the data in the corresponding cell at the time the graph is constructed or last updated, capturing the state of the cell for consistency during querying. The sequence number represents the total number of vectors that have been added to the corresponding cell up to the time of the graph’s construction, serving as a monotonic insertion counter that can be compared against the current cell’s sequence number to detect newly inserted vectors for potential merging into query results.

The system receives 730 a query for nearest neighbors of a target vector. The target vector may be generated by a client application, retrieved from stored data, or computed dynamically from an input object (such as an image, text embedding, or other high‑dimensional representation). The query specifies parameters such as the number of neighbors to return, accuracy requirements, or filtering conditions. Upon receiving the query, the system initiates a search process that leverages the clustered cell structure and associated per‑cell graphs to efficiently locate candidate nearest neighbors.

The system identifies 740, by traversing a plurality of centroids of cells, one or more centroids closest to the target vector. This identification may be accomplished by evaluating similarity distances between the target vector and each centroid, or by traversing a centroid‑level routing graph that connects centroids in accordance with their proximity relationships. The one or more centroids determined to be closest correspond to the cells that are most likely to contain the nearest neighbors of the target vector. This step narrows the search space by focusing subsequent graph‑based searches on only the most relevant cells rather than scanning the entire dataset.

For each of the plurality of cells identified using the closest centroids, the system performs 750 a graph‑based search to identify one or more candidate nearest neighbors in the corresponding cell. The graph‑based search begins at an entry node determined from the centroid traversal and proceeds by following edges through the per‑cell graph to explore neighboring vectors. By traversing nodes connected by short‑range and, in some configurations, selected long‑range edges, the system efficiently identifies candidate vectors that are likely to be close to the target vector in similarity space.

The system determines 760 a distance between the target vector and each of the one or more candidate nearest neighbors identified during the graph‑based search. The chosen distance metric may be Euclidean distance, cosine similarity, or another domain‑appropriate measure. These distance computations are used to rank the candidate nearest neighbors and evaluate their relevance with respect to the target vector. In some embodiments, distance computation may be optimized by using vector quantization, approximate calculations, or pre‑computed partial results.

The system selects 770 one or more nodes from the one or more candidate nearest neighbors of the target vector based on the determined distances. Selection may involve ordering the candidates by ascending similarity distance and choosing the top‑K results according to the query parameters. Additional conditions may be applied during selection, such as filtering out vectors that do not meet secondary constraints, ensuring diversity among results, or applying tie‑breaking rules when multiple candidates have identical distances.

The system outputs 780 the selected one or more nodes as query results. The output may be returned to the requesting client system, stored for further processing, or used internally in downstream operations. The results may include the identifiers of the selected nodes, their corresponding vectors, associated metadata, and computed similarity distances. By combining clustering, centroid traversal, per‑cell graph searches, and precise distance‑based selection, the system provides efficient and accurate approximate nearest neighbor search results in large‑scale vector datasets.

### COMPUTER ARCHITECTURE

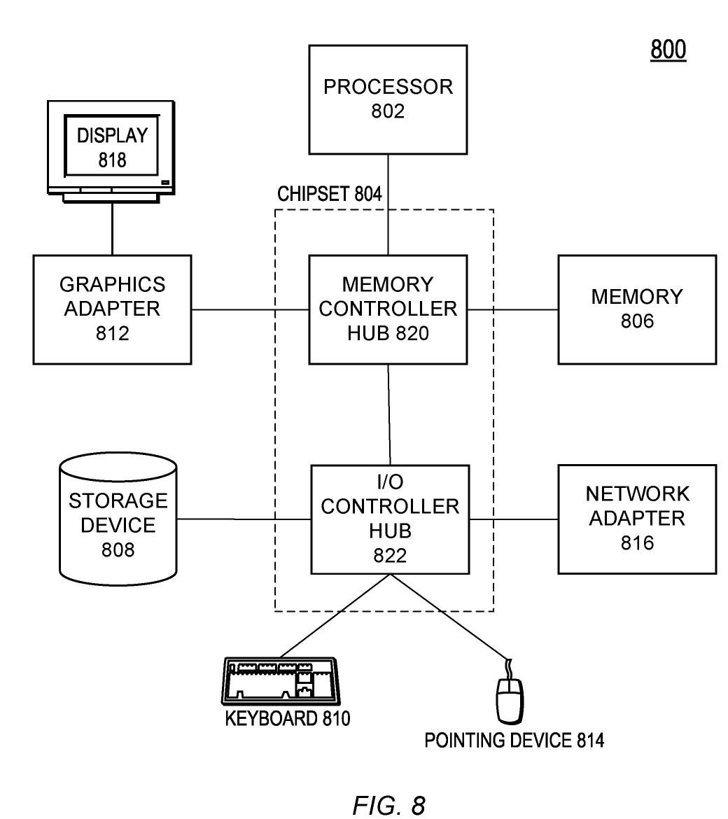

FIG. 8 is a high-level block diagram illustrating a functional view of a typical computer system for use as one of the entities illustrated in the system environment of FIG. 1 according to an embodiment. Illustrated are at least one processor 802 coupled to a chipset 804. Also coupled to the chipset 804 are a memory 806, a storage device 808, a keyboard 810, a graphics adapter 812, a pointing device 814, and a network adapter 816. A display 818 is coupled to the graphics adapter 812. In one embodiment, the functionality of the chipset 804 is provided by a memory controller hub 820 and an I/O controller hub 822. In another embodiment, the memory 806 is coupled directly to the processor 802 instead of the chipset 804.

The storage device 808 is a non-transitory computer-readable storage medium, such as a hard drive, compact disk read-only memory (CD-ROM), DVD, or a solid-state memory device. The memory 806 holds instructions and data used by the processor 802. The pointing device 814 may be a mouse, track ball, or other type of pointing device, and is used in combination with the keyboard 810 to input data into the computer system 800. The graphics adapter 812 displays images and other information on the display 818. The network adapter 816 couples the computer system 800 to a network.

As is known in the art, a computer system 800 can have different and/or other components than those shown in FIG. 8. In addition, the computer system 800 can lack certain illustrated components. For example, a computer system 800 acting as a server (e.g., a query server 112) may lack a keyboard 810 and a pointing device 814. Moreover, the storage device 808 can be local and/or remote from the computer system 800 (such as embodied within a storage area network (SAN)).

The computer system 800 is adapted to execute computer modules for providing the functionality described herein. As used herein, the term “module” refers to computer program instruction and other logic for providing a specified functionality. A module can be implemented in hardware, firmware, and/or software. A module can include one or more processes, and/or be provided by only part of a process. A module is typically stored on the storage device 1008, loaded into the memory 806, and executed by the processor 802.

The types of computer systems 800 used by the entities of FIG. 1 can vary depending upon the embodiment and the processing power used by the entity. For example, a client device 120 may be a mobile phone with limited processing power, a small display 818, and may lack a pointing device 814. The entities of the system 110, in contrast, may comprise multiple blade servers working together to provide the functionality described herein.

### ADDITIONAL CONSIDERATIONS

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

The language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

Some portions of the above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the element or component is present unless it is obvious that it is meant otherwise.

Where values are described as “approximate” or “substantially” (or their derivatives), such values should be construed as accurate +/- 10% unless another meaning is apparent from the context. From example, “approximately ten” should be understood to mean “in a range from nine to eleven.”

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs that may be used to employ the described techniques and approaches. Thus, while particular embodiments and applications have been illustrated and described, it is to be understood that the described subject matter is not limited to the precise construction and components disclosed.

What is claimed is:

1. A method for approximate nearest neighbor search on a vector dataset, comprising:
clustering a plurality of vectors into a plurality of cells, each cell associated with a centroid;
for each of the plurality of cells, generating a graph linking vectors that are sufficiently close to each other, wherein each graph is associated with a snapshot identifier and a sequence number, the snapshot identifier representing a version of data in a corresponding cell, and the sequence number representing a number of vectors that have been added to the corresponding cell;
receiving a query for nearest neighbors of a target vector;
identifying, by traversing a plurality of centroids of cells, one or more centroids closest to the target vector, the one or more centroids corresponding to one or more of the cells;
for each of the plurality of cells, performing a graph‑based search to identify one or more candidate nearest neighbors in the corresponding cell;
determining a distance between the target vector and each of the one or more candidate nearest neighbors;
selecting one or more nodes from the one or more candidate nearest neighbors of the target vector based on the determined distances; and
outputting the selected one or more nodes as query results.

2. The method of claim 1, further comprising:
receiving, during a new time interval associated with a new snapshot identifier, one or more mutations including at least one of: insertion of one or more new vectors, deletion of one or more existing vectors, or modification of one or more existing vectors;
determining whether the one or more mutations meet a rebuild condition of corresponding graph; and
in response to determining that the rebuild condition is met,
determining a new sequence number of the corresponding graph based on the one or more mutations; and
updating the corresponding graph of a corresponding cell to include the one or more mutations associated with the new sequence number.

3. The method of claim 2, wherein the rebuild condition comprises at least one of: (i) a number of mutations since a last graph build exceeding a threshold, or (ii) a percentage increase in node count relative to the last graph build.

4. The method of claim 2, wherein each of the one or more new vectors is assigned a monotonically increase sequence number when inserted into a corresponding cell, and the new sequence number of the corresponding graph is a new highest sequence number corresponding to a most recently inserted new vector.

5. The method of claim 2, wherein updating the corresponding graph comprises:
in response to deleting a node, identifying a nearest neighbor of the deleted node in the corresponding graph; and
replacing edges to the deleted node with edges to the nearest neighbor of the deleted node.

6. The method of claim 5, wherein replacing edges to the deleted node with edges to the nearest neighbor of the deleted node is further based on:
(i) a duplicate-connection check, including determining whether a corresponding edge already exists, and replacing an edge to the deleted node in response to determining that the corresponding edge does not exist; or
(ii) a similarity-distance tolerance check, including determining whether the corresponding edge has a distance below a pre-defined threshold, and replacing the edge to the deleted node in response to determining that the distance is below the pre-defined threshold.

7. The method of claim 1, further comprising:
storing edges of each graph in a memory‑efficient encoded format by:
storing a first vector value corresponding to a first node in a first data structure with a first bit length;
determining a delta value between the first vector value corresponding to the first node and a second vector value corresponding to a second node; and
storing the delta value as a value associated with the second node in a second data structure with a second bit length.

8. The method of claim 7, wherein storing the delta value comprises:
determining a magnitude of the delta value;
determining the second bit length for storing the delta value based on the magnitude of the delta value; and
storing the delta value in a data structure with the determined second bit length.

9. The method of claim 8, wherein determining the second bit length for storing the delta value is further based on whether a number of nodes in a corresponding graph exceeds a first threshold and whether the delta value exceeds a second threshold.

10. The method of claim 1, further comprising:
selecting one or more graphs associated with corresponding centroids that are accessed at frequencies greater than a predetermined threshold;
caching, in memory, the selected one or more graphs; and
storing, on disk, one or more graphs associated with remaining centroids that are accessed at frequencies no greater than the predetermined threshold.

11. A non-transitory computer-readable medium, storing instructions, that when executed by one or more processors, cause the one or more processors to perform steps, comprising:
clustering a plurality of vectors into a plurality of cells, each cell associated with a centroid;
for each of the plurality of cells, generating a graph linking vectors that are sufficiently close to each other, wherein each graph is associated with a snapshot identifier and a sequence number, the snapshot identifier representing a version of data in a corresponding cell, and the sequence number representing a number of vectors that have been added to the corresponding cell;
receiving a query for nearest neighbors of a target vector;
identifying, by traversing a plurality of centroids of cells, one or more centroids closest to the target vector, the one or more centroids corresponding to one or more of the cells;
for each of the plurality of cells, performing a graph‑based search to identify one or more candidate nearest neighbors in the corresponding cell;
determining a distance between the target vector and each of the one or more candidate nearest neighbors;
selecting one or more nodes from the one or more candidate nearest neighbors of the target vector based on the determined distances; and
outputting the selected one or more nodes as query results.

12. The non-transitory computer-readable medium of claim 11, the steps further comprising:
receiving, during a new time interval associated with a new snapshot identifier, one or more mutations including at least one of: insertion of one or more new vectors, deletion of one or more existing vectors, or modification of one or more existing vectors;
determining whether the one or more mutations meet a rebuild condition of corresponding graph; and
in response to determining that the rebuild condition is met,
determining a new sequence number of the corresponding graph based on the one or more mutations; and
updating the corresponding graph of a corresponding cell to include the one or more mutations associated with the new sequence number.

13. The non-transitory computer-readable medium of claim 12, wherein the rebuild condition comprises at least one of: (i) a number of mutations since a last graph build exceeding a threshold, or (ii) a percentage increase in node count relative to the last graph build.

14. The non-transitory computer-readable medium of claim 12, wherein each of the one or more new vectors is assigned a monotonically increase sequence number when inserted into a corresponding cell, and the new sequence number of the corresponding graph is a new highest sequence number corresponding to a most recently inserted new vector.

15. The non-transitory computer-readable medium of claim 12, wherein updating the corresponding graph comprises:
in response to deleting a node, identifying a nearest neighbor of the deleted node in the corresponding graph; and
replacing edges to the deleted node with edges to the nearest neighbor of the deleted node.

16. The non-transitory computer-readable medium of claim 15, wherein replacing edges to the deleted node with edges to the nearest neighbor of the deleted node is further based on:
(i) a duplicate-connection check, including determining whether a corresponding edge already exists, and replacing an edge to the deleted node in response to determining that the corresponding edge does not exist; or
(ii) a similarity-distance tolerance check, including determining whether the corresponding edge has a distance below a pre-defined threshold, and replacing the edge to the deleted node in response to determining that the distance is below the pre-defined threshold.

17. The non-transitory computer-readable medium of claim 11, the steps further comprising:
storing edges of each graph in a memory‑efficient encoded format by:
storing a first vector value corresponding to a first node in a first data structure with a first bit length;
determining a delta value between the first vector value corresponding to the first node and a second vector value corresponding to a second node; and
storing the delta value as a value associated with the second node in a second data structure with a second bit length.

18. The non-transitory computer-readable medium of claim 17, wherein storing the delta value comprises:
determining a magnitude of the delta value;
determining the second bit length for storing the delta value based on the magnitude of the delta value; and
storing the delta value in a data structure with the determined second bit length.

19. The non-transitory computer-readable medium of claim 18, wherein determining the second bit length for storing the delta value is further based on whether a number of nodes in a corresponding graph exceeds a first threshold and whether the delta value exceeds a second threshold.

20. A computing system, comprising:
one or more processors; and
a non-transitory computer-readable medium, storing instructions, that when executed by the one or more processors, cause the one or more processors to perform steps, comprising:
clustering a plurality of vectors into a plurality of cells, each cell associated with a centroid;
for each of the plurality of cells, generating a graph linking vectors that are sufficiently close to each other, wherein each graph is associated with a snapshot identifier and a sequence number, the snapshot identifier representing a version of data in a corresponding cell, and the sequence number representing a number of vectors that have been added to the corresponding cell;
receiving a query for nearest neighbors of a target vector;
identifying, by traversing a plurality of centroids of cells, one or more centroids closest to the target vector, the one or more centroids corresponding to one or more of the cells;
for each of the plurality of cells, performing a graph‑based search to identify one or more candidate nearest neighbors in the corresponding cell;
determining a distance between the target vector and each of the one or more candidate nearest neighbors;
selecting one or more nodes from the one or more candidate nearest neighbors of the target vector based on the determined distances; and
outputting the selected one or more nodes as query results.
